(19) United States
(12) Patent Application Publication
(10) Pub. No.: US 2009/0060669 A1
(43) Pub. Date: Mar. 5, 2009

(54) Coated drill and a method of making the same

(75) Inventors: Maria Astrand, Storvreta (SE); Peter Muller, Bad Homburg (DE); Thomas Heil, Bruchkobel (DE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 11/896,744

(22) Filed: Sep. 5, 2007

(51) Int. Cl. B23B 27/14; B21K 5/04

(52) U.S. Cl. 408/144; 76/108.6

(57) ABSTRACT

The present invention relates to a twist drill comprising a cemented carbide or high speed steel substrate and a multilayered aperiodic (Ti,Al)N-coating having a binary A/B/A/B/A/B structure, where the composition of layer A is AlₓTi₁₋ₓN, where x preferably is from about 0.40 to about 0.75, more preferably from about 0.50 to about 0.70, and most preferably from about 0.60 to about 0.68, and the composition of layer B is Ti_{y}Al_{1-y}N, where y preferably is from about 0.50 to about 1.0, more preferably from about 0.60 to about 0.90, and most preferably from about 0.70 to about 0.80 and the composition for the whole coating is Ti_{z}Al_{1-z}N, where z preferably is from about 0.35 to about 0.75, more preferably from about 0.40 to about 0.65 and where the average thickness of layer A and B is between about 1 to about 200 nm, preferably about 2 to about 50 nm.

The present invention also relates to a method of making a twist drill.

Drills according to the present invention have an increased wear resistance and thus longer tool life.

### BACKGROUND OF THE INVENTION

The present invention relates to a twist drill for metal machining coated with an aperiodic (Ti,Al)N multilayered coating and a method of manufacturing such a twist drill invention.

Twist drills are often coated with a hard material to increase tool life by enhancing the wear resistance. A high wear resistance is advantageous especially at the tip area of the twist drill where the cutting takes place. The trend within the cutting industry goes towards increased cutting speeds, feeds and more and more difficult materials to cut. This results in higher demands on the wear resistance. Also properties like low friction and smoothness are advantageous, mainly on other parts of the twist drill, for example to enhance chip transportation. The chip transport is particularly important when the drilled depth is relatively large compared to the nominal diameter.

A common wear mechanism in drilling is wear in the cutting edge resulting in a weaker edge followed by chipping. If chipping occurs in the middle of the cutting edge, uncontrolled chip formation can occur. If the chipping occurs closer to the periphery, corner fracture can occur. Increasing the edge toughness and wear resistance is thus of great importance to increase tool life. One possible solution to decrease the risk of thermal and/or mechanical cracking is to use a multilayered coating. The multilayered coating is expected to act as a crack inhibitor as an initial crack going down the coating may be redirected at any sublayer interface.

WO 98/48072 relates to a cutting tool comprising a body of sintered cemented carbide, ceramic or high speed steel on which at least on the functional parts of the surface of the body, a thin, adherent, hard and wear resistant coating is applied. The coating comprises a laminar, multilayered structure of refractory compounds in polycrystalline, non-repetitive form MX/NX/MX/NX . . . where the alternating layers MX and NX are composed of metalnitrides or carbides. The sequence of individual layer thicknesses is essentially aperiodic throughout the entire multilayered structure.

### OBJECTS AND SUMMARY OF THE INVENTION

It is an object of the present invention is to provide a twist drill with good wear resistance and thereby obtaining an increased tool life.

In one embodiment of the invention, there is provided a twist drill comprising a cemented carbide or high speed steel substrate and a multilayered (Ti,Al)N coating wherein the coating comprises a binary A/B/A/B/A/B structure, where the composition of layer A is AlₓTi₁₋ₓN, where x is from about 0.40 to about 0.75, the composition of layer B is Ti_{y}Al_{1-y}N, where y is from about 0.50 to about 1.0, the composition of the whole coating is Ti_{z}Al_{1-z}N, where z is from about 0.30 to about 0.70, and the average thickness of the individual layers A and B is between about 1 to about 200 nm.

In another embodiment of the invention, there is provided a method of making a drill comprising providing a substrate, and onto said substrate depositing, by conventional PVD techniques, an aperiodic multilayered coating having a A/B/A/B/A/B structure from targets of pure Ti and/or TiAl alloy(s) chosen so the composition of layer A is AlₓTi₁₋ₓN, where x is from about 0.40 to about 0.75, the composition of layer B is Ti_{y}Al_{1-y}N, where y is from about 0.50 to about 1.0, and the composition for the whole coating is Ti_{z}Al_{1-z}N, where z is from about 0.30 to about 0.70, and the average thickness of layer A and B is between about 1 to about 200 nm.

### DETAILED DESCRIPTION OF THE PREFERRED EMBODIMENTS

It has been found that thin multilayered coatings, where a layer consisting of a (Ti,Al)N with a high Al-content is alternated with a (Ti,Al)N-layer with high Ti-content, improves the tool life of the drill.

The present invention relates to a coated twist drill comprising a substrate body, preferably of cemented carbide or high speed steel, and an aperiodic multilayered (Ti,Al)N coating.

By multilayered structure is herein meant a structure comprising at least 5, preferably at least 10 individual layers. However, it can comprise up to several thousand individual layers.

The drill according to the present invention is provided with an aperiodic (Ti,Al)N multilayer comprising a binary A/B/A/B/A/B structure with thin alternating sublayers A and B being repeated throughout the entire coating.

By aperiodic is understood that the thickness of a particular individual layer in the multilayered structure does not depend on the thickness of an individual layer immediately beneath nor does it bear any relation to an individual layer above the particular individual layer. Hence, the multilayered structure does not have any repeat period in the sequence of individual layer thicknesses.

The composition of each individual layer in the multilayered structure cannot easily be measured without contribution from adjacent layers due to the small thickness. What can be measured is the average composition over the whole multilayer structure. However, the composition of each individual layer can be estimated from the composition of the targets, that is the sources used for the individual layers during deposition, but that does not give an exact composition. When thicker layers have been deposited, thick enough to be analyzed individually, it has been found that the composition of the deposited layers can differ with a few percentages compared to the composition of the target material. Due to this fact, any composition of the individual layers of the multilayered structure according to the present invention mentioned herein after are estimations from the compositions of the targets used during deposition.

In the aperiodic multilayered coating according to the present invention the composition of sublayer A is AlₓTi₁₋ₓN, where x is from about 0.40 to about 0.75, preferably from about 0.50 to about 0.70, and more preferably from about 0.60 to about 0.68. The composition of layer B is Ti_{y}Al_{1-y}N, where y is from about 0.50 to about 1.0, preferably from about 0.60 to about 0.90 and more preferably from about 0.70 to about 0.80. The composition of the whole coating as measured by e.g., microprobe or EDS is Ti_{z}Al_{1-z}N, where z is preferably from about 0.30 to about 0.70 and more preferably from about 0.40 to about 0.60. Due to the aperiodic nature of the coating, the thickness of each individual layer will vary but in average the layer thickness is within from about 1 to about 200 nm, preferably from about 2 to about 50 nm.

The total thickness of the coating measured on the peripheral surface is from about 0.5 μm to about 7 μm, preferably from about 1 to about 5 μm.

The drill preferably has a diameter of from about 0.5 to about 35 mm, more preferably from about 2 to about 25 mm.

In one embodiment of the present invention, the coating further comprises a top layer of sufficient thickness, preferably from about 0.1 to about 1 μm, of Ti₁₋ₓAlₓN where x is equal to or greater than about 0.5 and equal to or less than about 0.70, preferably Ti_{0.33}Al_{0.67}N or Ti_{0.50}Al_{0.50}N, to give a visible, black intrinsic color.

In yet another embodiment of the present invention, the coating further comprises a top layer having a bright color facilitating visual wear detection, of sufficient thickness, preferably from about 0.1 to about 1 μm, preferably of Ti_{0.75}Al_{0.25}N, Ti_{0.84}Al_{0.16}N, Ti_{0.90}Si_{0.10}N or TiN to give a visible purple, bronze or yellow intrinsic color.

The present invention also relates to a method of making a twist drill comprising providing a cemented carbide or high speed steel substrate, and onto said substrate depositing a PVD-coating comprising a laminar, multilayered structure of A/B/A/B . . . . The targets are chosen so that the composition of the layers A and B are AlₓTi₁₋ₓN and Ti_{y}Al_{1-y}N respectively, where x preferably is from about 0.40 to about 0.75, more preferably from about 0.50 to about 0.70 and most preferably from about 0.60 to about 0.68 and where y preferably is from about 0.50 to about 1.0, more preferably from about 0.60 to about 0.90, and most preferably from about 0.70 to about 0.80. The composition of the whole coating, made according to the present invention, as measured by e.g., microprobe or EDS is Ti_{z}Al_{1-z}N, where z preferably is from about 0.30 to about 0.70, more preferably from about 0.40 to about 0.60. Due to the aperiodic nature of the coating, the thickness of each layer will vary but in average the layer thickness of the deposited individual layers is within from about 1 to about 200 nm, preferably from about 2 to about 50 nm.

The total thickness of the deposited coating as measured on the peripheral surface is from about 0.5 to about 7 μm, preferably from about 1 to about 5 μm.

The aperiodic structure is obtained by, during the deposition process, randomly opening and closing shutters from individual layer targets, or by randomly switching said targets on and off. Another conceivable method is by randomly rotating or moving the to-be-coated substrates, in front of said targets. This is preferably done by placing the substrates on a 3-fold rotating substrate table arranged in order to obtain the aperiodic structure. The 3-fold rotation can be adjusted with regard to rotating speed and rotating direction, clockwise or counter clockwise.

The coating can be deposited using any one of the common PVD techniques, such as e-beam evaporation, magnetron sputtering or cathodic arc evaporation. Preferably the coating is deposited using cathodic arc evaporation using two or three pairs of arc sources consisting of pure Ti and/or TiAl alloy(s), in an N₂ or mixed N₂+Ar gas atmosphere.

In one embodiment of the present invention, a top layer is deposited having a sufficient thickness, preferably from about 0.1 to about 1 μm, of Ti₁₋ₓAlₓN where x is equal to or greater than about 0.5 and equal to or less than about 0.70, preferably Ti_{0.33}Al_{0.67}N or Ti_{0.50}Al_{0.50}N to give a visible, black intrinsic color.

In yet another embodiment a top layer, having a lighter color to facilitate visual wear detection, is deposited of sufficient thickness, preferably from about 0.1 to about 1 μm, preferably of Ti_{0.75}Al_{0.25}N, Ti_{0.84}Al_{0.16}N, Ti_{0.90}Si_{0.10}N or TiN to give a visible purple, bronze or yellow intrinsic color.

Finally, the drills are preferably post-treated to obtain a smooth surface, by, e.g., wet blasting, dry blasting, polishing, grinding, brushing, etc.

The invention is additionally illustrated in connection with the following examples, which are to be considered as illustrative of the present invention. It should be understood, however, that the invention is not limited to the specific details of the examples.

### EXAMPLE 1 (INVENTION)

8 mm drills with two different geometries, Geometry 1 and 2, were made from cemented carbide with a composition of 10 wt-% Co and balance WC. These were coated according to the present invention with an aperiodic multilayered (Ti,Al)N coating, using cathodic arc evaporation. The multilayer structures were deposited from three pairs of arc targets made out of two different chemical compositions, 1 and 2, with the drills mounted on a 3-fold rotating substrate table arranged in order to obtain the aperiodic structure. The arc evaporation was performed in an Ar+N₂-atmosphere. After depositing the coating, the drills were subjected to a wet blasting treatment.

The composition of the arc targets and the average composition of the coating are shown in Table 1.

The multilayered structure had a sequence of individual layers with an aperiodic, i.e. non-repetitive thickness. Cross section transmission electron microscopy investigation revealed that the individual nitride layer thicknesses ranged from 2 to 50 nm, and the total number of layers in each layer system exceeded 100.

TABLE 1

| | | | Average | Thickness |
|---|---|---|---|---|
| | | | chemical | (on periphery) |
| Drill No. | Target 1 | Target 2 and 3 | composition | [μm] |
| 1 (inv.) | Ti_{0.75}Al_{0.25} | Ti_{0.33}Al_{0.67} | Ti_{0.50}Al_{0.50}N | 3.0 |

### EXAMPLE 2 (REFERENCE)

Drills with the same two geometries as in example 1, Geometry 1 and 2, were coated with a commercial (Ti,Al)N-coating.

### EXAMPLE 3

Drills with Geometry 1 made according to Example 1 were compared to drills with the same geometry made according to Example 2. Three drills of each drill type were tested in a drilling operation during the following cutting conditions:

| | |
|---|---|
| Work piece material: | SS2541 (34CrNiMo6) |
| Operation: | Drilling |
| V_{c} [m/min] | 100 |
| Feed [mm/rev] | 0.15 |
| a, depth of hole [mm] | 20 |
| Internal coolant | yes |

The results can be seen below. The number of drilled holes is an average of three tests. Tool life criterion was either a measurable wear criterion of v_{B}=0.3 mm on the clearance or 0.5 mm in the corner, or tool breakage identified by too long chip formation, very bad sound, or chipping over the whole margin.

TABLE 2

| Drill type No. | No. holes |
|---|---|
| Invention, geometry 1 | 4000* |
| Commercial, geometry 1 | 2790 |

*Interrupted after 4000 holes, before tool life criterion was reached.

### EXAMPLE 4

Drills with Geometry 2 made according to Example 1 were compared to drills with the same geometry made according to example 2. Three drills of each drill type were tested in a drilling operation during the following cutting conditions:

| | |
|---|---|
| Work piece material: | SS2541 (34CrNiMo6) |
| Operation: | Drilling |
| V_{c} [m/min] | 100 |
| Feed [mm/rev] | 0.15 |
| a, depth of hole [mm] | 20 |
| Internal coolant | yes |

The results can be seen below. The number of drilled holes is an average of three tests. Tool life criterion was either a measurable wear criterion of v_{B}=0.3 mm on the clearance or 0.5 mm in the corner, or tool breakage identified by too long chip formation, very bad sound, or chipping over the whole margin.

TABLE 3

| Drill type No. | No. holes |
|---|---|
| Invention, Geometry 2 | 1550 |
| Commercial, Geometry 2 | 927 |

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A twist drill comprising a cemented carbide or high speed steel substrate and a multilayered (Ti,Al)N coating wherein the coating comprises a binary A/B/A/B/A/B structure, where the composition of layer A is AlₓTi₁₋ₓN, where x is from about 0.40 to about 0.75, the composition of layer B is Ti_{y}Al_{1-y}N, where y is from about 0.50 to about 1.0, the composition of the whole coating is Ti_{z}Al_{1-z}N, where z is from about 0.30 to about 0.70, and the average thickness of the individual layers A and B is between about 1 to about 200 nm.

2. A twist drill of claim 1 wherein the aperiodic multilayered coating have a total thickness of from about 0.5 ∞m to about 7 μm.

3. A twist drill of claim 1 wherein the substrate comprises cemented carbide.

4. A twist drill of claim 1 wherein the substrate comprises high speed steel.

5. A twist drill of claim 1 wherein in composition A, x is from about 0.50 to about 0.70, in composition B, y is from about 0.60 to about 0.90, in the composition of the whole coating, z is from about 0.40 to about 0.60 and the average thickness of the individual layers is between about 2 to about 50 nm.

6. A twist drill of claim 5 wherein in composition A, x is from about 0.60 to about 0.68 and in composition B, and y is from about 0.70 to about 0.80.

7. A twist drill of claim 2 wherein the aperiodic multilayered coating has a total thickness of from about 1 to about 5 μm.

8. Method of making a drill comprising
providing a substrate, and;
onto said substrate depositing, by conventional PVD techniques, an aperiodic multilayered coating having a A/B/A/B/A/B structure from targets of pure Ti and/or TiAl alloy(s) chosen so the composition of layer A is AlₓTi₁₋ₓN, where x is from about 0.40 to about 0.75, the composition of layer B is Ti_{y}Al_{1-y}N, where y is from about 0.50 to about 1.0, and;
the composition for the whole coating is Ti_{z}Al_{1-z}N, where z is from about 0.30 to about 0.70, and the average thickness of layer A and B is between about 1 to about 200 nm.

9. A method according to claim 8 wherein the aperiodic multilayered coating have a total thickness of from about 0.5 μm to about 7 μm.

10. A method according to claim 8 wherein the substrate comprises cemented carbide.

11. A method according to claim 8 wherein the substrate comprises high speed steel.

12. The method of claim 8 wherein in composition A, x is from about 0.50 to about 0.70 in composition B, y is from about 0.60 to about 0.90 and in the composition of the whole coating, z is from about 0.40 to about 0.60.

13. The method of claim 12 wherein in composition A, x is from about 0.60 to about 0.68 and in composition B, and y is from about 0.70 to about 0.80.

14. The method of claim 9 wherein the aperiodic multilayered coating has a total thickness of from about 1 to about 5 μm.
